(19) United States
(12) Patent Application Publication
(10) Pub. No.: US 2009/0133369 A1
(43) Pub. Date: May 28, 2009

(54) DUST MANAGEMENT SYSTEM FOR A HARVESTER

(75) Inventors: Earl Richard Coward, Swift Current (CA); Gary Lane Francis, Swift Current (CA)

Correspondence Address: THOMPSON HINE L.L.P.;Intellectual Property Group, P.O. BOX 8801, DAYTON, OH, 45401-8801, US

(73) Assignee: REM MANUFACTURING LTD., Swift Current (CA)

(21) Appl. No.: 12/019,087

(22) Filed: Jan. 24, 2008

(30) Foreign Application Priority Data
Nov. 22, 2007 (CA) 2612046

(51) Int. Cl. B01D 45/04

(52) U.S. Cl. 55/385.1

(57) ABSTRACT

A dust management device for a harvester, including ducting in secure engagement with the harvester and adapted to receive air, airborne harvest dust and other materials discharged from the harvester. The dust management device further includes a diffuser-separation chamber, in secure engagement with the harvester, in engagement with the ducting, and adapted to receive air, airborne harvest dust and other materials from the ducting. The diffuser-separation chamber redirects air and airborne harvest dust back into the harvester and discharges other material from the harvester.

This application claims priority to Canadian Patent Application Serial No. ______, entitled DUST MANAGEMENT SYSTEM FOR A HARVESTER in the name of REM Manufacturing Ltd., filed on, Nov. 22, 2007, the entire contents of which are hereby incorporated by reference.

### FIELD OF THE INVENTION

The present invention relates to dust management systems, and more particularly, relates to dust management systems for an almond nut harvester and other harvesting devices.

### BACKGROUND OF THE INVENTION

The automated harvesting of almond nuts (and for example, pecans, and other nuts, fruits, vegetables and grains), using modern harvesting equipment (hereinafter collectively referred to as “almond harvesters” or “harvesters” or “harvester”) produces large volumes of very fine dust particles (hereinafter sometimes referred to as “harvest dust”), which, when exhausted to the environment in airborne or suspended form, may create clouds of harvest dust which poses significant occupational health and safety issues to the individuals operating and in close proximity to the machine during operation. Furthermore, a significant nuisance, and even hazard, may be created during the harvesting season, when this airborne or suspended harvest dust, in cloud form, moves beyond the field being harvested, and into the neighboring areas, including, neighboring fields, roads, highways, neighborhoods and other dust sensitive environments. The overall negative effect of the exhausting of harvest dust by harvesters is being studied, and there is a need to reduce the amount of harvest dust which is exhausted into the environment during the harvesting of almond nuts (and other nuts, fruits, vegetables and grains).

It is desirable to provide an almond harvester which reduces, or substantially reduces the amount of harvest dust which is exhausted to the environment during the harvesting of almond nuts (and other nuts, fruits, vegetables and grains).

### SUMMARY OF THE INVENTION

Accordingly, one object of the present invention is to provide a harvester which reduces, or substantially reduces the amount of harvest dust which is exhausted to the environment during the harvesting of almond nuts (and other nuts, fruits, vegetables and grains).

According to one aspect of the present invention, there is provided a dust management device for a harvester, comprising, ducting, in secure engagement with the harvester and adapted to receive air, airborne harvest dust and other materials discharged from the harvester, a diffuser-separation chamber, in secure engagement with the harvester, in engagement with the ducting, and adapted to receive air, airborne harvest dust and other materials from the ducting, wherein the diffuser-separation chamber redirects air and airborne harvest dust back into the harvester and discharges other material from the harvester.

One advantage of the present invention is that it provides a harvester which reduces, or substantially reduces the amount of harvest dust which is exhausted from the harvester into the air in the environment near the harvester during the harvesting of almond nuts (and other nuts, fruits, vegetables and grains).

### BRIEF DESCRIPTION OF THE DRAWINGS

An illustrative embodiment of the present invention is described below with reference to the accompanying drawings, in which:

FIG. 1 is a schematic diagram illustrating the movement of harvested material, harvest dust and air through a typical (prior art) almond harvester;

FIG. 2 is a schematic diagram, partly in ghost, illustrating the movement of harvested material, harvest dust and air through one embodiment of the present invention attached to an almond harvester;

FIG. 3 is a view, partially in ghost, of a portion of the intermediate duct, inwardly directed elbow, and diffuser-separation chamber of one embodiment of the present invention installed on an almond harvester;

FIG. 4 is a view, partially in ghost, of one embodiment of the diffuser-separation chamber of one embodiment of the present invention installed on a almond harvester illustrating the air deflection foils and hinged lower door of one embodiment of the present invention;

FIG. 5 is an enlarged view of the embodiment of the diffuser-separation chamber illustrated in FIG. 4;

FIG. 6 is a reverse angle view, partially in ghost, of the embodiment of the diffuser-separation chamber illustrated in FIG. 4; and

FIG. 7 is the reverse angle view of FIG. 6, with the illustration of structural and other additional elements, and the flow of air, harvest dust and other materials through the diffuser-separation chamber and into the harvester.

### DETAILED DESCRIPTION

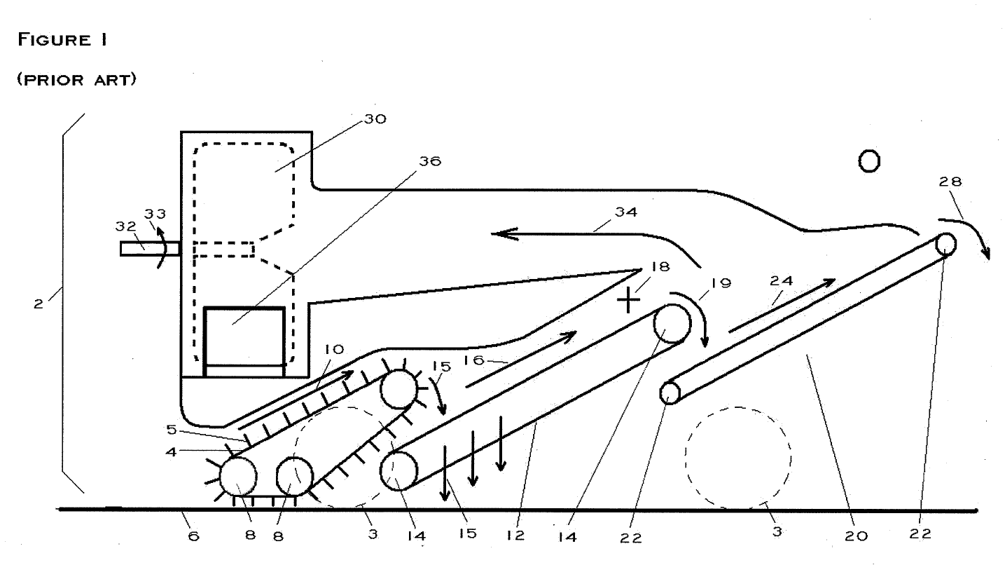

With reference to FIG. 1, a schematic diagram of a typical (prior art) almond harvester 2 is provided, such as, for example, the Weiss/McNair 9800 California Special™ or Flory Industries Model 480™ harvester, mounted on wheels 3 and being either self propelled, or adapted for being towed through the field 6 to be harvested, FIG. 1 illustrating the flow of harvested material and air through the harvester. As illustrated in FIG. 1, the harvested material is harvested from the field 6 by way of a pickup belt 4 having flights 5 thereon to lift the harvestable material from the field, which pickup belt 4 is driven and mounted on sprockets 8, the harvested material traveling along the pickup belt 4 (as illustrated by the arrow 10), falling a short distance (as illustrated by the arrow 15) onto a first conveyor 12 (driven by and mounted on sprockets 14), and as it travels along the first conveyor 12 (as illustrated by the arrow 16), some dirt and small pebbles fall through small holes in the first conveyor 12 (the falling dirt illustrated by the arrows 15) back into the field 6, the harvested material thereafter falling a short distance (as illustrated by the arrow 19) onto a second conveyor 20 (the second conveyor typically being made of, for example, a flat wire almond chain and driven by and mounted on sprockets 22), the harvested material thereafter traveling along the second conveyor 20 (as illustrated by the arrow 24) and finally falling off the end of the second conveyor 20 (as illustrated by the arrow 28), into a bin (not shown) or other temporary storage device adapted to temporarily receive and store harvested almonds during the harvesting process. A rotary blower 30, powered by a rotating power take off shaft 32 (the rotation of which is illustrated by the arrow 33), draws air through the harvester as illustrated by the arrow 34, which air will during the operation of the harvester contain plant leaves and stems, dirt, harvest dust and other material (hereinafter sometimes collectively referred to as “harvest debris”) which will have become suspended in the air as the harvested debris falls from the first conveyor 12 to the second conveyor 20 and as the flow of air passes through and in close proximity to the harvest debris (an air lock 18 may be provided to substantially reduce or eliminate the flow of air past the air lock 18 and to thereby increase the flow of air through and in close proximity to the harvest debris falling from the first conveyor 12 to the second conveyor 20). The air (and the harvest dust suspended in the air) is expelled into the environment from the blower 30 through an exhaust duct 36 (and in one embodiment of the prior art device, directed rearwardly by a duct elbow (not shown) attached to the exhaust duct 36). In this manner, the almonds are separated, or substantially separated from the harvest debris so that the harvested almonds are substantially free of harvest debris.

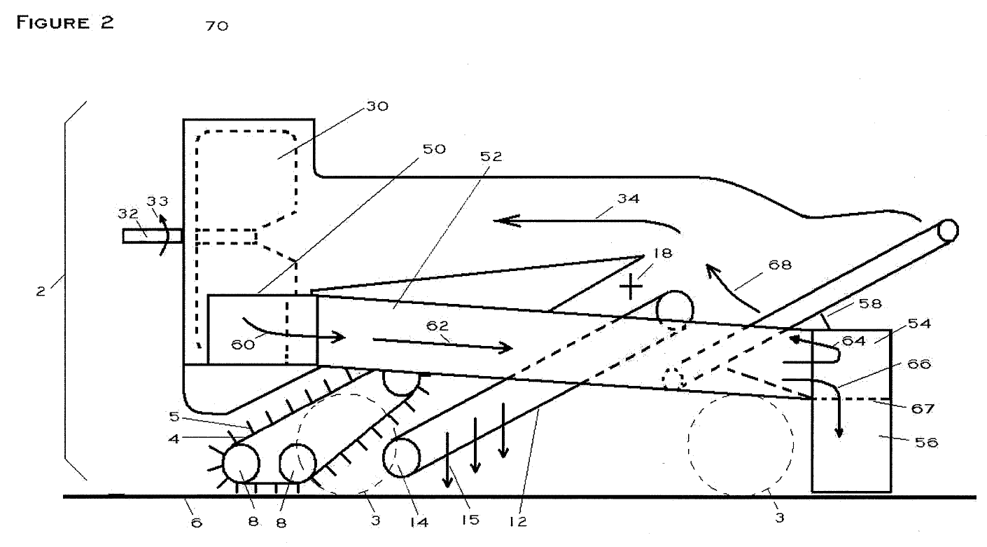

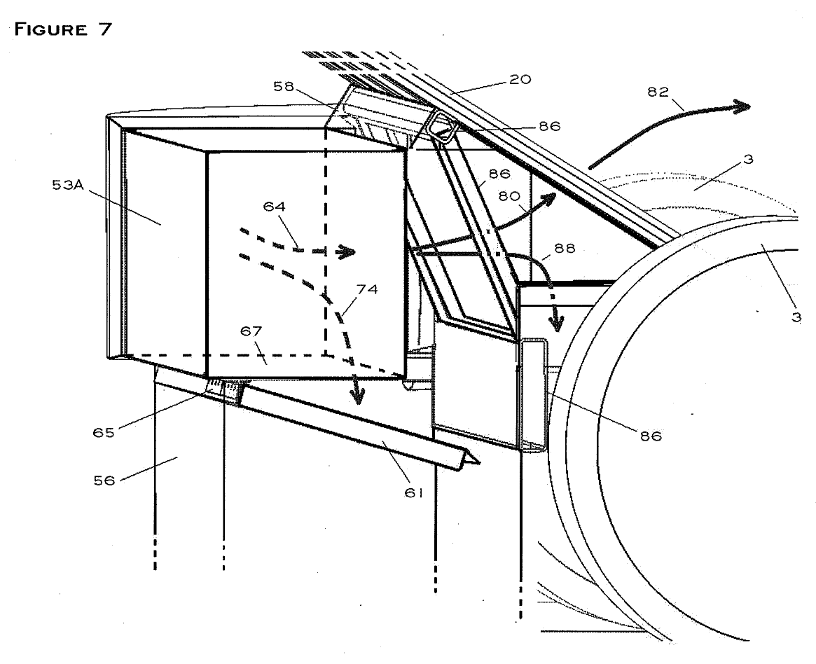

In one embodiment of the present invention, as illustrated in FIG. 2, a rearwardly-directed elbow duct 50 is bolted, riveted or otherwise securely fastened to the blower vent 36 (or in the event that a rearwardly directed elbow duct is already provided on the harvester, it is understood that the pre-existing rearwardly-directed elbow duct may be utilized instead), an intermediate duct 52 is bolted, riveted or otherwise securely fastened to the rearwardly-directed elbow duct 50, an inwardly directed elbow duct 54 is bolted, riveted or otherwise securely fastened to the intermediate duct 52, which inwardly directed elbow duct 54 is bolted, riveted or otherwise securely fastened to a diffuser-separation chamber 53 as more fully described herein, which diffuser-separation chamber 53 is bolted, screwed or otherwise securely mounted to structural members of the harvester 86 as illustrated in FIG. 7 by bolts, screws or in such other manner known to a person skilled in the art. In one embodiment of the present invention, a cyclone (not shown) or other filtering or dust particle precipitating device or system may be inserted, for example, along the intermediate duct, or elsewhere on the harvester in a manner known to a person skilled in the art to provide supplementary air cleaning capacity to the harvester and exhausting cleaned air to the environment in a manner known to a person skilled in the art.

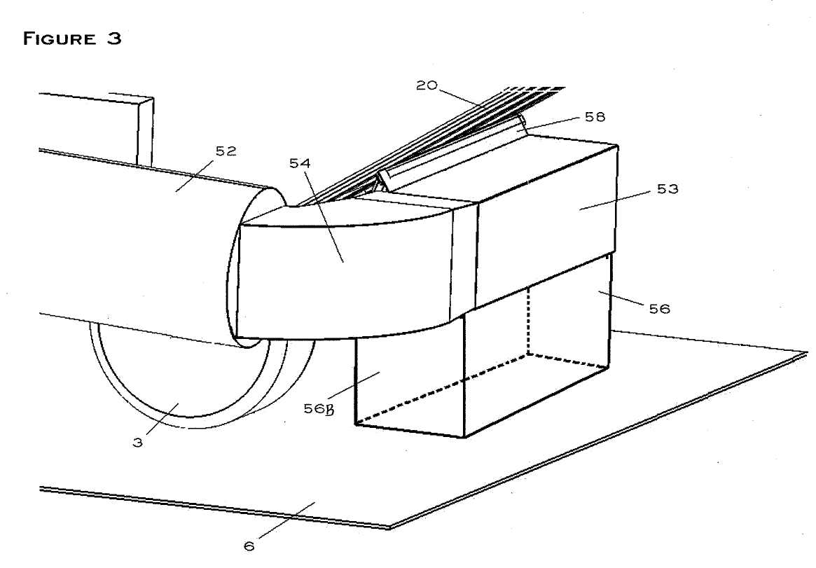

As illustrated in FIGS. 2 and 3, in the illustrated embodiment of the present invention, a soft walled passageway 56B formed, for example, by four or a plurality of rubber curtains 56 (or alternatively by such other materials as would be known to a person skilled in the art) securely attached to and suspended from the harvester 2/diffusion-separation chamber 53, directs the flow of harvest debris discharged from the bottom opening 67 of the diffuser-separation chamber 53 toward the surface of the field 6 as more fully described herein.

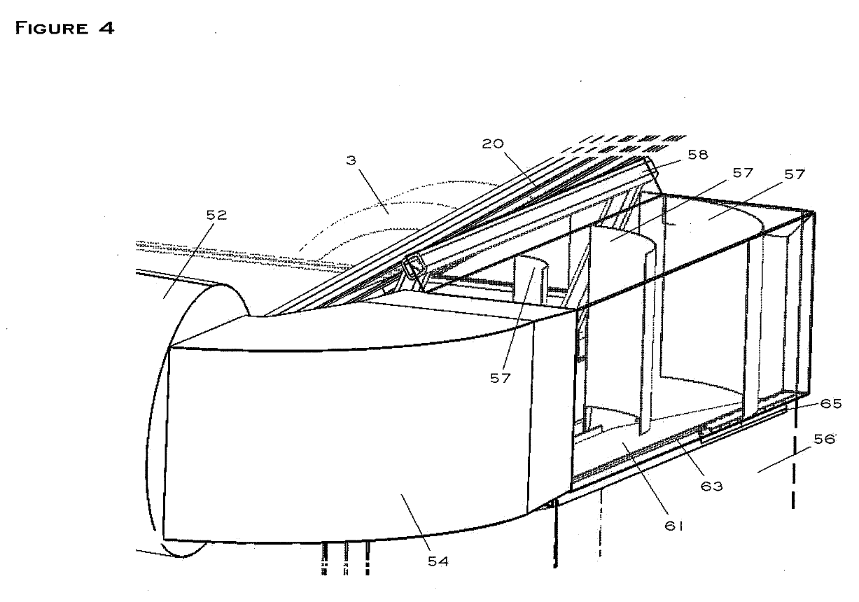

As illustrated in FIG. 4, in the illustrated embodiment of the present invention, curved air deflection foils 57 are welded or otherwise securely fastened to top of the diffuser-separation chamber 53 and suspended into the interior of the diffuser-separation chamber 53, which air deflection foils 57 direct a portion of the air and airborne harvest debris which flows into the air deflection foils 57 in a generally forwardly direction, some of the airborne harvest debris materials impacting on the surface of the air deflection foils 57 or otherwise being slowed down while in the diffuser-separation chamber 53 may fall through the bottom opening 67 of the diffuser-separation chamber 53 as more fully described herein (it being understood that in one alternative embodiment of the present invention, no air deflections foils are utilized and in another alternative embodiment of the present invention, non-curved air deflection foils may be utilized, it also being understood that the air deflection foils may alternatively be welded or otherwise securely fastened to the back wall or such other part of the diffuser-separation chamber 53 as would be known to a person skilled in the art).

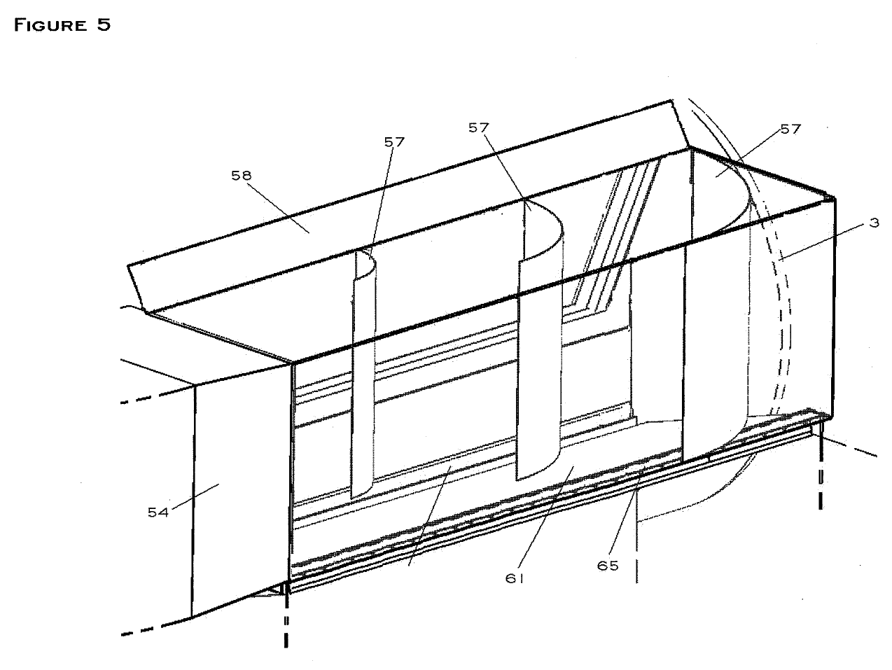

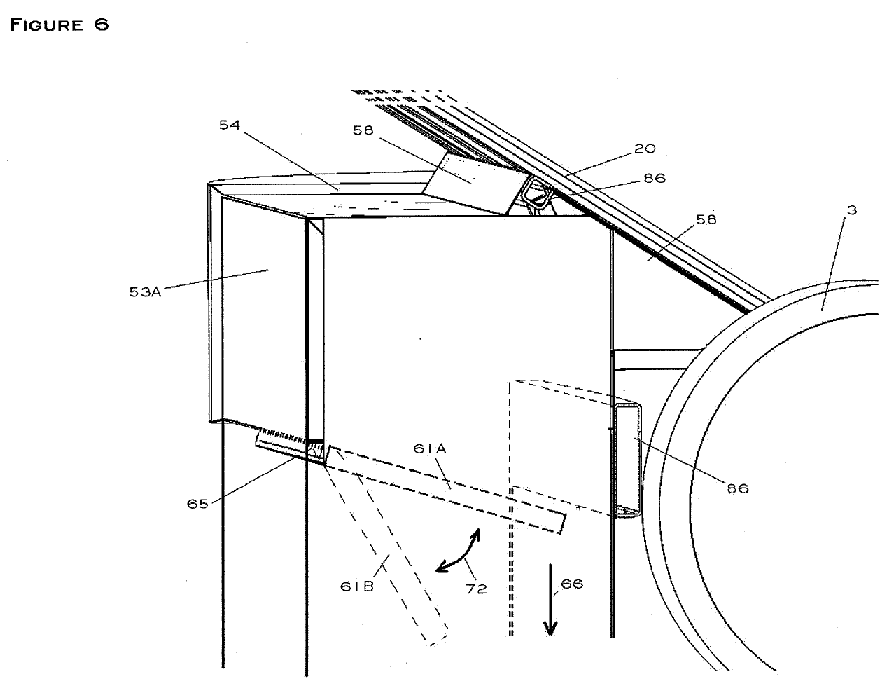

As illustrated in FIGS. 4, 5, 6, and 7, in one embodiment of the present invention, a hinged lower door 61 is provided, the hinged lower door 61 being attached by way of a hinge 65 to the lower end of the back wall 53A of the diffuser-separation chamber 53, and in one embodiment of the present invention, temporarily locked into a partially opened position by a bolt or screw or such other means as would be known to a person skilled in the art, or alternatively, moveable by way of an adjustment mechanism (not shown, including, for example, a lever, chain or such other device as known to a person skilled in the art) between a closed or substantially closed position 61A to an open position 61B it being understood that while in the closed or substantially closed position 61A, the hinged lower door 61 blocks or substantially blocks harvest debris from falling through the opening 67 in the bottom of the diffuser-separation chamber 53 and into the field 6 as more fully described herein.

In operation, as illustrated in FIGS. 2 and 7, air (and airborne harvest debris) enter the diffuser-separation chamber 53, a portion of which is directed by the diffuser-separator chamber to a generally forwardly direction (as illustrated by the arrow 64), some airborne harvest debris moves downwardly as it separates from the air flow (as illustrated by the arrow 74) which unsuspended harvest debris thereafter may pass through the opening 67 in the bottom of the diffuser-separation chamber 53 as previously described. The portion of air which has been forwardly directed by the diffuser-separation chamber 53 will continue to contain some harvest debris therein (including harvest dust suspended in the air flow), and the harvest debris materials (including suspended harvest dust) that is small enough to pass through the holes in the second conveyor 20, may pass there-through (as illustrated by the arrow 80) and re-enter the airflow within the harvester directed toward the blower 30 (as illustrated by the arrows 82 and 34), the harvest debris materials (for example, leaves, stems and the like) which are not small enough to pass through the holes in the second conveyor 20, being downwardly directed toward the field 6 (as illustrated by the arrow 88) as it comes into contact with the second conveyor 20. Additionally, some of the harvest debris material will come into contact with structural members 86 of the harvester, resulting in some of the harvest debris materials (for example, leaves, stems and the like) being slowed sufficiently and separated from the air stream allowing it to fall to the ground at the base of the harvester. In the above-described manner, harvest dust is separated from the other harvest debris, and remains suspended in the airflow and recycled through the harvester until it is no longer suspended in the air flow, whereupon it passes to the surface of the field 6 in non-suspended form.

In the illustrated embodiment of the present invention, appropriately shaped, positioned and securely fastened air flow and dust blocking panels 58 are positioned on the diffuser-separation chamber 53 and in one embodiment, positioned on the harvester frame itself as required to minimize the amount of dusty air that exits from the harvester, to direct air flow in the desired manner to reduce the likelihood that airborne harvest dust will move into the environment outside of the harvester during the operation of the harvester.

The present invention has been described herein with regard to various embodiments. However, it will be obvious to persons skilled in the art that a number of variations and modifications can be made without departing from the scope of the invention as described herein.

What is claimed is:

1. A dust management device for a harvester, comprising:
a. ducting, in secure engagement with the harvester and adapted to receive air, airborne harvest dust and other materials discharged from the harvester; and
b. a diffuser-separation chamber, in secure engagement with the harvester, in engagement with the ducting, and adapted to receive air, airborne harvest dust and other materials from the ducting;
wherein the diffuser-separation chamber redirects air and airborne harvest dust back into the harvester and discharges other material from the harvester.
